(19) United States
(12) Patent Application Publication
(10) Pub. No.: US 2004/0059676 A1
(43) Pub. Date: Mar. 25, 2004

(54) Secure data storage on open systems

(76) Inventors: Vincent Rozendaal, Essex (GB); Stephen Kelly, Hertfordshire (GB)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/311,737

(22) PCT Filed: Jun. 12, 2001
(86) PCT No.: PCT/EP01/06657

(30) Foreign Application Priority Data
Jun. 19, 2000 (GB) 0015006.0

(51) Int. Cl. G06F 17/60

(52) U.S. Cl. 705/50

(57) ABSTRACT

A method of storing data relating to a batch of items, such as mail items, on a processor-based system in a secure fashion is described. The method comprises receiving data relating to a parameter of each item in the batch and cryptographically protecting the database using a crypto engine in a secure vault. In a preferred embodiment, the method comprises sending the received data for each item to the crypto engine in the vault, which is operable to produce a message authentication code based on the received data and to tag the received data with the message authentication code, writing the data tagged with the message authentication code to the openly accessible database, and repeating the aforementioned steps for each subsequent item in the batch. The parameter of each item may be a physical parameter of the items, such as their respective weights, or a rating parameter, such as a postage value or class.

The present invention relates to methods and systems for storing data on a processor-based system, such as a desktop computer, in a secure fashion. The data in question may be that relating to mail generated by a mailer and handed over to a postal service which distributes and delivers the generated mail in return for appropriate payment provided by the mailer. It is therefore important that the data in question should be secured against fraud and/or accidental error.

Conventionally, data of such sensitivity has been secured by means of a secure coprocessor and a secure vault as described in U.S. Pat. No. 4,775,246 or U.S. Pat. No. 4,853,523. Use of an open database is described in WO 95/19016, but Tygar et al. describe why this is unsatisfactory in “Cryptography: It's not just for Electronic Mail Anymore” (CMU-CS-93-107).

In one aspect, the present invention provides a method of storing data relating to a batch of items such as mail items on a processor-based system in a secure fashion, the method comprising: receiving data relating to a parameter of each item in the batch; and cryptographically protecting the database using a crypto engine in a secure vault.

In one embodiment, the method further comprises sending the received data for each item to said crypto engine in the vault which is operable to produce a message authentication code based on the received data and to tag the received data with the message authentication code; writing the data tagged with the message authentication code to said openly accessible database; and repeating the aforementioned steps for each subsequent item in the batch.

According to a further aspect of the invention, there is provided a method of storing data relating to a batch of items such as mail items on a processor-based system in a secure fashion, the method comprising: receiving data relating to a parameter of an item in the batch; sending the received data relating to the value of the parameter for said item to a crypto engine in a secure vault which is operable to produce a message authentication code based on the received data and to tag the received data with the message authentication code; writing the data tagged with the message authentication code to an openly accessible database; and repeating the aforementioned steps for each subsequent item in the batch.

By a message authentication code (MAC) is meant a cryptographically generated code typically comprising a string of numbers and/or letters which is generated from a string of data (or message) using a cryptographic algorithm, in order to permit authentication of the message in question either by comparison of the MAC with the result of applying the same cryptographic algorithm to the same message again at a later time or by comparison of the message itself with the result of decrypting the MAC. In the context of the present invention, each line of data in the database which pertains to an item in the batch may provide a message suitable for encryption using the cryptographic algorithm. The cryptographic algorithm is provided by the crypto engine in the vault and may, for example, be implemented by a triple DES symmetric algorithm within the ownership of the postal service.

According to another aspect of the invention, there is provided a method of storing data relating to a batch of items such as mail items on a processor-based system in a secure fashion, the method comprising: setting a plurality of batch counters in a secure vault to initial numerical values respectively representing an initial count of the number of items in the batch and an initial value of a physical parameter of the items in the batch; receiving data relating to the value of the physical parameter of an item in the batch; sending the received data relating to the value of the physical parameter for said item to a crypto engine in the vault which produces a message authentication code based on the received data and which tags the received data with the message authentication code; incrementing the batch counter numerical value representing the number of items in the batch by one and incrementing the numerical value of the batch counter representing the value of the physical parameter of the items in the batch by an amount determined on the basis of the received data relating to the value of the physical parameter for the item in question; writing the data tagged with the message authentication code to an openly accessible database; repeating the aforementioned steps conducted following the initial setting of the batch counters for each subsequent item in the batch; validating the tagged database entries using the numerical value of at least one of the batch counters; and cryptographically protecting the database using the crypto engine.

The method just described may further comprise setting a further batch counter in the secure vault to an initial numerical value representing an initial value of a rating parameter for the items in the batch, receiving data relating to the value of the rating parameter for said item, sending the received data relating to the value of the rating parameter for said item to the crypto engine which produces said message authentication code based on the value of the rating parameter as well as on the value of the physical parameter of the item, incrementing the numerical value of the further batch counter representing the value of the rating parameter of the items in the batch by an amount determined on the basis of the received data relating to the value of the rating parameter for the item in question, and repeating the aforementioned steps conducted following the initial setting of the further batch counter for each subsequent item in the batch.

The method according to the invention is particularly well suited to storing data pertaining to a batch of items of mail. However, the data stored may equally well pertain to any other items which are typically processed in a batch-wise fashion, in which the items in the batch vary according to some physical parameter.

Preferably, the parameter of the items in the batch is their weight. Alternatively, the parameter may instead be their size format, such as DIN A4. C4 and so on. If the items in question are items of mail, the parameter may be their postage value or a postal service code corresponding to their postage class or mode of sending, such as express delivery, recorded delivery, parcel post, etc.

Following validation of the tagged database entries and cryptographic protection of the database using the crypto engine, the method may further comprise transmitting an electronic message relating to the database to a postal service. Typically, this further transmission step may involve putting the validated and cryptographically protected database in a format suitable for transmission over the internet. The cryptographic protection of the database therefore ensures that even though the database is being transmitted over a public switched network, any tampering with the contents of the database will be detectable upon its receipt by the postal service.

In the event that the items in question are items of mail, the method may further comprise generating a postage indicium from the data received in relation to an item of mail in the batch and attaching the postage indicium to the item. The postage indicium thus generated may be in an encrypted form generated using the crypto engine and may be applied to the item of mail using a suitable printing means. Upon receipt of the item of mail by the postal service, if the postal service has also received the validated and cryptographically protected database, comparison of the postage indicium on the item of mail with the data for that item of mail contained in the database can be used as part of a process of confirming that the batch of mail corresponds to the database for that batch.

The tagged database entries may be validated before the database is cryptographically protected in one of several ways. The database may be validated by comparing the total number of item entries in the database with a batch counter in the vault representing the number of items in the batch or by comparing the total value of the physical parameter of the items in the database with a batch counter in the vault representing the value of the parameter of the items in the batch, or both. If the database also comprises data relating to the value of a rating parameter for the items in the batch, the step of validating the database may comprise comparing the total value of the rating parameter of the items in the database with the batch counter in the vault representing the value of the rating parameter of the items in the batch. According to these techniques, the tagged database entries are validated using the numerical value of at least one of the batch counters. Alternatively or additionally, the tagged database entries may be validated using the crypto engine. In such a case, two alternative techniques are possible. Firstly, the database may be validated by producing a message authentication code using the crypto engine from the data for an item in the database and comparing the message authentication code thus produced with the message authentication code from the database corresponding to the data in question. Secondly, the database may be validated by decrypting a message authentication code from the database using the crypto engine and comparing the result of the decryption with the data for the item in the database corresponding to the message authentication code in question. Validating the database using the crypto engine according to either one of these techniques may be conducted in addition to validating the database using the numerical value of at least one of the batch counters.

The step of cryptographically protecting the database using the crypto engine may typically comprise attaching an electronic signature to the database.

In a further aspect, the present invention provides a processor-based system for storing data pertaining to a batch of items such as items of mail in a secure fashion, the system comprising: a crypto engine in a secure vault adapted to receive data relating to the value of a parameter of an item in the batch, generate a message authentication code on the basis thereof and tag the received data with the message authentication code; and an openly accessible database for storing the tagged data.

According to another aspect of the invention, there is provided a processor-based system for storing data pertaining to a batch of items such as items of mail in a secure fashion, the system comprising: a secure vault comprising a plurality of batch counters for recording numerical values respectively representing the number of items in the batch and a value of a physical parameter of the items in the batch; a crypto engine in the vault adapted to receive data relating to the value of the physical parameter of an item in the batch, generate a message authentication code on the basis thereof and tag the received data with the message authentication code; an openly accessible database for storing the tagged data; and means for cryptographically protecting the database using the crypto engine.

The secure vault may further comprise a batch counter for recording a numerical value representing the value of a rating parameter for the items in the batch, in which case the crypto engine would also be adapted to receive data relating to the value of the rating parameter of the item in question and generate said message authentication code on the basis thereof as well on the basis of data relating to the value of the physical parameter of the item in question.

Preferably, the processor-based system comprises a personal computer and the secure vault comprises a microprocessor as the crypto engine, the personal computer having means for removably connecting the secure vault thereto.

In a convenient embodiment, the secure vault is a smart card and the means for connecting the secure vault to the personal computer is a smart card reader. However, in another embodiment, the secure vault may instead be a vault of the type described in U.S. Pat. Nos. 4,853,523 and 4,862,375 to Talmadge and the means for removably connecting the vault to the personal computer such means as are described in these two references.

Alternatively, the processor-based system may comprise a personal computer and the secure vault may be located remotely from the personal computer, the personal computer having means for establishing a telecommunication link with the remotely located vault.

The method and system of the present invention have the advantages of allowing data to be stored in an openly accessible database of a processor-based system, such as a desktop computer, in a secure fashion. This allows large volumes of sensitive data to be stored without fear of error or fraud, rather than just summary information concerning the items in the batch and numerical values representing the number of items in the batch, the total value of the parameter of the items in the batch or the total value of the rating parameter for the items in the batch.

“Open” in this context means not requiring a particular password or other similar security measure to gain access to the database.

The features and advantages of the present invention will be better understood from the following description, given by way of example, in association with the accompanying drawings, in which:

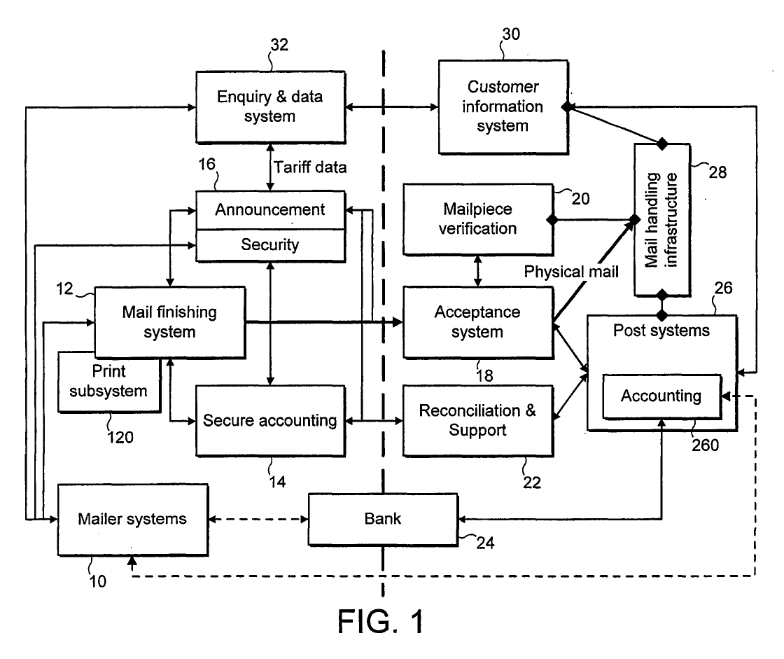

FIG. 1 schematically shows an example of the component parts of a mailer-postal service interface;

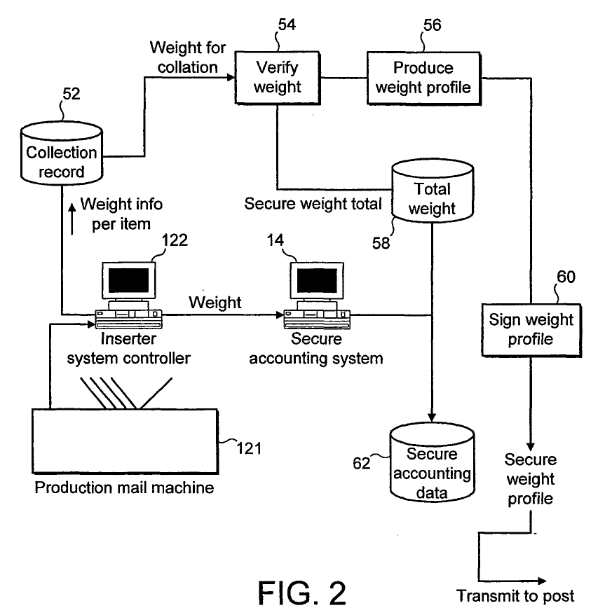

FIG. 2 schematically shows some of the processes carried out on the mailer side of the mailer-postal service interface of FIG. 1;

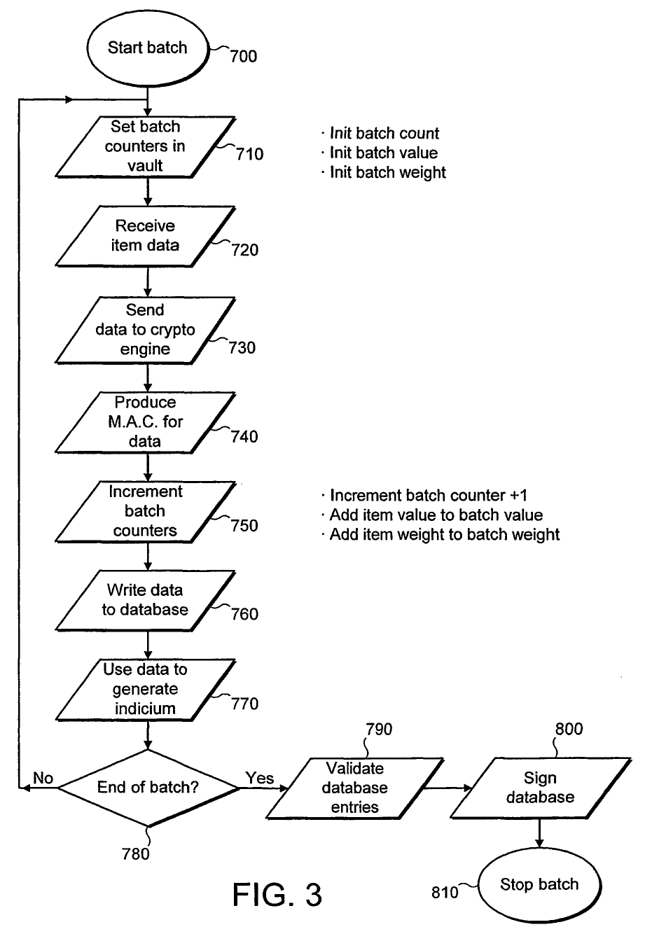

FIG. 3. represents process steps conducted by means of a secure accounting system of the mailer according to an embodiment of the method of the invention in order to generate a database of information relating to items of mail in a batch of mail;

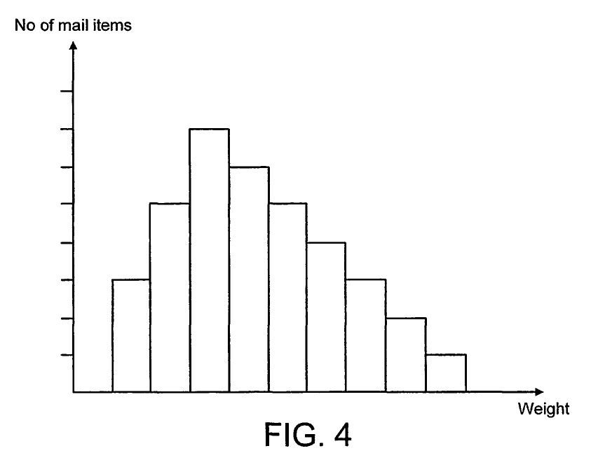

FIG. 4 represents an example of a weight distribution profile of the items of mail in the batch; and

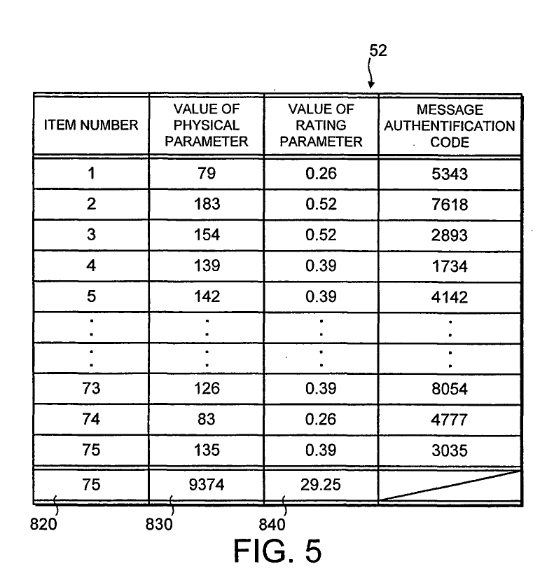

FIG. 5 shows an example of a database generated by means of the method of FIG. 3.

A mailer-postal service interface may be represented schematically as shown in FIG. 1, in which the enumerated boxes represent functional components of the interface and the vertical dashed line down the centre of FIG. 1 divides functional components of the interface generally associated with the mailer (shown in the left-hand side of FIG. 1) from functional components of the interface generally associated with the postal service (show in the right-hand side of FIG. 1). In the following, the mailer may also be referred to as a customer of the postal service.

The mailer-postal service interface shown in FIG. 1 is suitable for handling bulk volumes of mail, the hand-over of which from the mailer to the postal service may be announced by means of a statement of mailing submission (SMS). A statement of mailing submission is a message or document sent from the mailer to the postal service and describing the composition of a submission of mail. The process of hand-over, of one or more submissions of mail, for acceptance by the postal service is called induction. Where several submissions are handed over as part of a single transaction, the set of submissions concerned is documented in a statement of induction (SoI). A statement of induction is a message defining the set of submissions inducted into the postal system as part of a single hand-over transaction. A submission is part of a mailing which is inducted (possibly with submissions from other mailings) as a single unit. A mailing is a logical collection of mail, from the perspective of the mailer. Normally, a mailing will comprise mail which it is logical to generate as a unit and will be the unit for which the mailer expects to be invoiced. For physical production purposes, mailings may be broken down into one or more production batches. For induction purposes, on the other hand, they are broken down into submissions, Faith individual submissions being separately inducted. This may occur, for example, when the production of a mailing is spread over several days. Some postal services, however, may require each submission to be treated as a separate mailing, or may limit the number of submissions into which a mailing is split.

The functional components enumerated in FIG. 1 will now be described.

A mailer systems component 10 represents customer data processing systems, dealings with normal business and office functions including mail generation and company accounting. For example, such data processing systems include desktop computers running application programs for word processing and for maintaining internal records and accounts.

A mail finishing system component 12 represents specialised equipment and control systems used for converting raw documents derived from the mailer systems 10 into finished mail, ready for hand-over to the postal service. Such equipment includes inserting, enveloping and addressing or labelling machines, postage metering equipment. bundling and wrapping equipment, etc.

A mail finishing system 12 comprises a mail finishing print sub-system 120 which is responsible for the composition and printing of proof-of-payment indicia on mail items. It receives data required for a digital proof-of-payment indicium to be added to a mail item, which may be encoded in appropriate symbology, and controls the process for the printing thereof on mail items.

A secure accounting system 14 is responsible for maintaining secure accounting information for items of mail produced by mail finishing system 12 and comprises a secure vault which returns to its controlling IT system a digital signature for use in the authentication of postal payment indicia. At the end of each mail production run by the mailer, the vault also provides a cryptographic signature for a statement of mailing submission.

During a mail run, an announcement system 16 (described below) passes postal rating information (e.g. the mail type and weight) received from the customer and/or the mail finishing system 12 to the secure accounting system 14. The secure accounting system supports postage payment security requirements by means of encryption and authentication, maintains accounting information relating to payments effected by the mailer, be they pre-paid or a credit balance outstanding and unused payment tokens, returns a postage amount based on input parameters, together with a digital signature or other payment evidencing token, and maintains a summary of mailpiece types so that a statement of mailing submission can be generated at the completion of the mail run.

To fulfil these functions, the secure accounting system 14 uses cryptographic techniques, based on design-specific algorithms and key management systems. It communicates with other devices and systems primarily through the announcement system 16, but may communicate directly with reconciliation and support systems 22 used for maintenance of the mailer's systems and re-crediting of the mailer's postage account.

The announcement system 16 is responsible for controlling and interfacing with other components to ensure that the mail produced by the mailer is properly accounted for and provided with appropriate proof of payment in the form of digital indicia. Its main purpose is to complement the mailer and/or mail finishing systems 10, 12, adding to them the functionality needed to control the use of the secure accounting system 14, which accounts for and instructs printing of the digital indicium onto each mailpiece. The accounting system 14 is responsible for the compilation of data for statements of mailing submission but the electronic submission of these to the postal service acceptance system 18 and the processing of responses received from that system are conducted by the announcement system 16.

The acceptance system 18 supports the acceptance of mail into the postal service's mail handling environment and controls the hand-over of mail from the mailer to the postal service. This hand-over may take place either on the mailer's premises or in postal acceptance offices.

The acceptance system 18 accepts, records and acknowledges the arrival from mailers of statements of mailing. Data provided in each SMS are passed to the postal service's collection and other planning systems to support logistics optimisation, and to the mailpiece verification system 20 for revenue protection purposes.

The acceptance system 18 provides mail acceptance staff with an automated capability to authenticate incoming mail based on submitted statements of mailing submission. Where a mail submission can be reconciled with an SMS which describes it, the SMS is passed to the postal service accounting system 260 for accounting verification, revenue reconciliation and, in the case of post-invoicing, invoicing purposes. Receipt and acceptance of the mail submission is acknowledged to the customer's announcement system 16.

If no reconciliation is possible, the acceptance system 18 informs a postal service operator. When there is a justifiable suspicion that fraud has been attempted by the mailer, the acceptance system assists in obtaining evidence of this.

The acceptance system 18 may also be used in the acceptance of mail submissions for which no corresponding statement of mailing submission has been submitted. In this case, data for validation is gained from sampling individual mailpieces in the submission in question.

The mailpiece verification system 20 processes and authenticates the payment evidence and/or customer identification provided by the indicium printed on each mailpiece and collects information needed for accounting or accounting verification. In particular, it accepts data from individual mailpieces collected by the mail handling infrastructure, checks that such data presents acceptable evidence of payment for the services required, compares the data for consistency with information from the statement of mailing submission, where that exists, acknowledges to the acceptance system 18 the validity of the SMS involved, and passes data on payment evidence for payment management and fraud detection purposes to the acceptance system 18.

Reconciliation and support 22 is a collective name for a number of systems concerned with the management of postage accounting devices installed on the mailer's premises. Such systems provide postage value re-setting services, i.e. services for the re-setting or re-crediting of postage payment devices, for example to the secure accounting system 14, and monitoring and maintenance services, i.e. services concerned with ensuring the correct functioning and reliability of postage payment devices and with detecting and preventing attempts to tamper with them. Again, these services primarily concern the secure accounting system 14.

The reconciliation and support systems 22 may be owned and operated either by a postal administration, or by a third party, working on behalf of the postal administration concerned.

A bank component 24 represents the means by as which the mailer effects payment to the postal service, normally through the commercial or postal banking system.

Post systems 26 represent the postal data processing infrastructure, including systems for customer account management and traditional accounting (bookkeeping) systems.

The mail handling infrastructure component 2S represents infrastructure for automated mail processing, including optical character recognition (OCR) and bar-code sorting machines, delivery sequencing equipment, etc. The process control systems used to manage this infrastructure are also included.

For present purposes, mailpiece data capture comes primarily from hand-held scanning devices associated directly with the verification system 20, rather than from other infrastructure components.

The customer information system 30 is a system which supports the electronic reporting of, and access to, information on the acceptance and processing of the mailer's special category mail, the provision of postal information (both public and customer-contract specific) to assist the mailer in preparing mail for submission to the postal service, and the expression and recording of the mailer's preferences for the way mail is delivered to them.

The enquiry and data system 32 is the mailer's complement to the customer information system 30. It can be implemented using a standard worldwide web browser to access the customer information system 30.

In FIG. 1, physical mail follows the path represented by the bold arrow from mail finishing system 12 to acceptance system 18 and thence to mail handling infrastructure 28. Other arrows in FIG. 1 represents interchange of information relating to mail contents, including but not restricted to, for example, mail type and weight and accounting information and information for incorporation as part of the physical mail itself. Diamond-headed lines in FIG. 1, connecting component boxes 20, 26, 28 and 30 represent data integration conducted by the postal service.

FIG. 2 schematically shows some of the processes carried out by systems on the mailer side of the mailer-postal service interface shown in FIG. 1. Production mail machine 121 is an example of a mail finishing system represented by box 12 in FIG. 1 and may, for example, be an inserter machine for inserting collations into envelopes to create items of mail. Production mail machine 121 generates in inserter system controller 122 weight information concerning items of mail processed by mail machine 121. The weight information generated in inserter system controller 122 may be a measured weight for each item of mail processed by mail machine 121 if the mail machine 121 comprises a scale for weighing the items of mail or may alternatively be a calculated weight derived from other properties of each item of mail, such as the number of collations each item of mail contains, if the mail machine 121 does not comprise such a scale. Inserter system controller 122 uses the weight information thus generated to create a collation record 52 of the weight information for each item of mail. Furthermore, the inserter system controller passes the weight information to secure accounting system 14.

The steps conducted by secure accounting system 14 on the basis of this weight information are represented in FIG. 3. Initially, at step 700, secure accounting system 14 instructs mail machine 121 to start processing a new batch of mail. The secure accounting system 14 accordingly sets batch counters in the secure vault thereof to initial values representing the initial count of the number of items of mail in the batch, the initial postage value of the batch and the batch's initial weight. Usually, the initial count of the number of mail items in the batch, and the initial postage value and weight of the batch are all set to zero, although the initial weight may include a tare to compensate for the weight of a pallet or tray to be used for transporting the batch to the postal service. This step of setting the batch counters in the vault to their initial values is represented by step 710 in FIG. 3.

Then, in step 720, the secure accounting system 14 receives the weight and postage value data for the first item of mail in the batch from inserter system controller 122. At step 730, it sends this data to a crypto engine in the secure vault, which at step 740 produces a message authentication code (MAC) based on the weight and postage value data for the item of mail in question. The weight and postage value data for the item of mail is tagged with the message authentication code and then the batch counters are incremented at step 750 by incrementing the batch counter for the number of items of mail by one, adding the value of postage for the item of mail in question to the initial batch value and adding the weight of the item of mail to the initial batch weight. The tagged weight and postage value data for the item in question are then written to an openly accessible database of the secure accounting system in step 760. This database is represented by accounting data 62 in FIG. 2. Finally, in step 770, the weight and postage value information is used by the secure accounting system 14 to generate an indicium for the item of mail in question which is transmitted to the mail machine 121 via the controller 122 for application to the item of mail by print subsystem 120.

Next, at step 780, the secure accounting system 14 checks whether the end of the batch has been reached. If not, it returns in a loop to step 720 to receive weight and postage value data from the inserter system controller 122 for the next item of mail in the batch. Steps 720 to 770 are repeated for the next item of mail in the batch until at step 780, the accounting system 14 determines that the end of the batch has been reached. In repetition of steps 730 and 740 for subsequent items, the MAC from the previous line of data in the database may be sent together with the weight and postage value data for the next item of mail to the crypto engine in the secure vault to act as a seed number for the crypto engine to produce the MAC for the next item of mail in question. This can be used to provide an extra level of security. When the end of the batch has been reached, the database entries in the accounting system are validated in step 790.

Validation by the secure accounting system 14 may take one of several forms. A “horizontal” validation of one or more of the lines of data, each corresponding to one of the items of mail in the batch, may be conducted by comparison of the MAC for the line of data in question with the data contained in that line. Thus, referring to FIG. 5, which shows an example of the database generated by the secure accounting system 14, message authentication code “5343” may be compared with the data represented by item number “1”, weight “79” and postage value “0.26”. This “horizontal” verification may take the form of regeneration of a MAC from the data items in question and comparison of the regenerated MAC with the MAC represented in the right-hand column of the database or decryption of the MAC from the database and comparison of the result of this decryption with the data entries in that line of data. This “horizontal” validation may be conducted for all of the lines of data in the database or may be conducted using a statistical sampling procedure for convenience in the event of the database containing data for a large number of items of mail. Alternatively, the validation procedure represented by step 790 in FIG. 3 may be a “vertical” validation in which one or more of the following comparisons is conducted. Firstly, the total number of items in the batch stored in the batch counter of the secure vault may be compared with the total number of items 820 recorded in the database, which in the example of FIG. 5 is “75”. Secondly, the total value of the weight of the items in the batch stored in the batch counter of the secure vault may be compared with the total value of the weight 830 recorded in the database, which in the example of FIG. 5 is “9374”. Thirdly, the total value of the postage for the items in the batch stored in the batch counter in the secure vault may be compared with the total value of the postage 84 0 recorded in the database, which in the example of FIG. 5 is “29.25”. As mentioned, one or more of these different “vertical” validations may be carried out. Moreover, both “horizontal” and “vertical” validations may be conducted, depending upon the level of security that is required.

Following validation, the database 62 is signed with an electronic signature in step S00, before the secure accounting system 14 instructs the mail machine 121 to stop production of the batch in step 810. The secure accounting system 14 generates the electronic signature using an encryption algorithm contained in the secure vault, which may be the same or a different algorithm to that used to generate the MACs. By application of the electronic signature, the accounting data 62 becomes secure. The secure accounting data 62 generated by the process steps shown in FIG. 3 therefore represents a complete database of weight and postage value information for the items of mail in the batch, each line of weight and postage value data being accompanied by a MAC, and the entire record for that batch having been validated and signed with an electronic signature. This final form of the database 62 forms the basis for an electronic message which may be passed by the secure accounting system 14 to the announcement system 16 for transmission to the postal service as part of a statement of mailing submission.

Returning to FIG. 2, it can be seen that during processing of a batch by production mail machine 121 under control of inserter system controller 122, the contents of the secure vault of accounting system 14, including running totals of the weight and value of postage for the batch and the number of items of mail in the batch, are constantly changing. Upon completion of production of the batch, secure accounting system 14 has thus generated a secure record 58 of the total weight of the batch, as well as the secure accounting data 62 for the items of mail in the batch. Steps subsequently conducted according to this embodiment of the invention by announcement system 16 shown in FIG. 1 are represented by labelled boxes 54, 56 and 60 shown in FIG. 2.

Firstly, in step 54, the announcement system 16 verifies the total weight of the batch by comparing the secure record 58 for the total weight of the batch derived from vault of the secure accounting system 14 with the total weight for the batch derived from the collation record 52 stored in the inserter system controller 122. Secondly, in step 56, announcement system 16 produces a weight profile for the batch on the basis of the encrypted weight data for each item derived from accounting data 62. An example of a weight profile generated by announcement system 16 in step 56 is shown in FIG. 4. According to this example, accounting data 62 is analysed by allocating weight ranges to the items of mail in the batch and then counting the number of items of mail falling within each of the allocated weight ranges. In the example shown in FIG. 4, therefore, there are represented ten weight ranges which have been allocated to the batch, which respectively contain 0, 3, 5, 7, 6, 5, 4, 3, 2 and 1 items of mail, starting from the lowest weight range and moving towards the highest weight range. Although FIG. 4 shows a histogram which can be constructed from this analysis of the weight distribution of the batch, in reality, the analysis of the weight distribution performed by announcement system 16 will actually result in a string of electronic data. Thirdly, in step 60, using its security component shown in FIG. 1, the announcement system 16 adds an electronic signature to the electronic data representing the weight profile thus derived.

Finally, the secure accounting data 62 from secure accounting system 14 and the electronically signed, and hence secure, weight profile from announcement system 16 are transmitted to the postal service via the electronic link therewith. This transmitted information forms the statement of mailing submission for the batch of mail in question. The secure weight profile generated by announcement system 16 provides the postal service with an independent check on the accuracy of the secure accounting data 62 derived from the accounting system 14 of the mailer. This check can be carried out upon induction of the physical mail from the mailer into acceptance system 18 of the postal service shown in FIG. 1 by sampling the weight distribution of items of mail from the batch and comparing the results with the weight profile received from announcement system 16.

It will be appreciated that in the preferred embodiment the data is secured in several different ways which may be used in isolation, with a corresponding reduced level of security, or in combination. For example, the step of generating the MACs for each set of data may be omitted. Cryptographic protection of the database using an electronic signature may be sufficient in some circumstances. Alternatively, the electronic signature may be omitted, with reliance placed on the generation of MACs for security.

Although the present invention is particularly applicable to data relating to mail generated by a mailer and handed over to a postal service, it may also be applied to any data stored on an openly accessible database of a processor-based system, the security of which it is important to maintain.

1. A method of storing data relating to a batch of items such as mail items on a processor-based system in a secure fashion, the method comprising:
receiving (720) data relating to a parameter of each item in the batch; and
cryptographically protecting (800) the database using a crypto engine in a secure vault.

2. A method according to claim 1, wherein the step of cryptographically protecting (800) the database using the crypto engine comprises attaching an electronic signature to the database.

3. A method according to claim 1 or 2 further comprising:
sending (730) the received data for each item to said crypto engine in the vault which is operable to produce (740) a message authentication code based on the received data and to tag the received data with the message authentication code;
writing (760) the data tagged with the message authentication code to said openly accessible database; and
repeating (780) the aforementioned steps for each subsequent item in the batch.

4. A method of storing data relating to a batch of items such as mail items on a processor-based system in a secure fashion, the method comprising:
receiving (720) data relating to a parameter of an item in the batch;
sending (730) the received data relating to the value of the parameter for said item to a crypto engine in a secure vault which is operable to produce (740) a message authentication code based on the received data and to tag the received data with the message authentication code;
writing (760) the data tagged with the message authentication code to an openly accessible database; and
repeating (780) the aforementioned steps for each subsequent item in the batch.

5. A method according to claim 3 or 4 further comprising:
validating (790) the tagged database entries using the crypto engine.

6. A method according to claim 5 wherein the step of validating (790) the database comprises:
producing a message authentication code using the crypto engine from the data for an item in the database; and
comparing the message authentication code thus produced with the message authentication code from the database corresponding to the data in question.

7. A method according to claim 5 wherein the step of validating (790) the database comprises:
decrypting a message authentication code from the database using the crypto engine; and
comparing the result of the decryption with the data for the item in the database corresponding to the message authentication code in question.

8. A method according to any one of claims 3 to 7 further comprising:
setting (710) a plurality of batch counters in said secure vault to initial numerical values respectively representing an initial count of the number of items in the batch and an initial value of said parameter of the items in the batch;
incrementing (750) the batch counter numerical value representing the number of items in the batch and incrementing the numerical value of the batch counter representing the value of the parameter by an amount determined on the basis of the received data relating to the value of the parameter for each item; and
repeating (780) the aforementioned steps for each subsequent item in the batch.

9. A method of storing data relating to a batch of items such as mail items on a processor-based system in a secure fashion, the method comprising:
setting (710) a plurality of batch counters in a secure vault to initial numerical values respectively representing an initial count of the number of items in the batch and an initial value of a physical parameter of the items in the batch;
receiving (720) data relating to the value of the physical parameter of an item in the batch;
sending (730) the received data relating to the value of the physical parameter for said item to a crypto engine in the vault which produces (740) a message authentication code based on the received data and which tags the received data with the message authentication code;
incrementing (750) the batch counter numerical value representing the number of items in the batch by one and incrementing the numerical value of the batch counter representing the value of the physical parameter of the items in the batch by an amount determined on the basis of the received data relating to the value of the physical parameter for the item in question;
writing (760) the data tagged with the message authentication code to an openly accessible database;
repeating (780) the aforementioned steps conducted following the initial setting of the batch counters for each subsequent item in the batch;
validating (790) the tagged database entries using the numerical value of at least one of the batch counters; and
cryptographically protecting (800) the database using the crypto engine.

10. A method according to claim 8 or 9, further comprising:
setting (710) a further batch counter in the secure vault to an initial numerical value representing an initial value of a rating parameter for the items in the batch;
receiving (720) data relating to the value of the rating parameter for said item;
sending (730) the received data relating to the value of the rating parameter for said item to the crypto engine which produces (740) said message authentication code based on the value of the rating parameter as well as on the value of the physical parameter of the item;
incrementing (750) the numerical value of the further batch counter representing the value of the rating parameter of the items in the batch by an amount determined on the basis of the received data relating to the value of the rating parameter for the item in question; and
repeating (780) the aforementioned steps conducted following the initial setting of the further batch counter for each subsequent item in the batch.

11. A method according to claim 10, wherein the items are mail items and the rating parameter is the postage value of the items of mail.

12. A method according to claim 10, wherein the items are mail items and the rating parameter is a postal service code corresponding to the postage class and/or mode of sending of the items of mail.

13. A method according to any one of claims 9 to 12, wherein the step of validating (790) the database comprises:
comparing the total number (820) of item entries in the database with the batch counter in the vault representing the number of items in the batch and or comparing the total value (830) of the physical parameter of the items in the database with the batch counter in the vault representing the value of the physical parameter of the items in the batch.

14. A method according to any one of claims 9 to 12, wherein the step of validating (790) the database comprises comparing the total value (840) of the rating parameter of the items in the database with the batch counter in the vault representing the value of the rating parameter of the items in the batch.

15. A method according to any preceding claim, wherein the parameter is the weight of the items in the batch.

16. A method according to any preceding claim, wherein the parameter is the size format of the items in the batch.

17. A method according to any preceding claim, further comprising transmitting an electronic message relating to the database to a postal service.

18. A method according to any preceding claim, further comprising generating (770) a postage indicium from the data received in relation to an item of mail in the batch and attaching the postage indicium to said item.

19. A processor-based system (14) for storing data pertaining to a batch of items such as items of mail in a secure fashion, the system comprising:
a crypto engine in a secure vault adapted to receive data relating to the value of a parameter of an item in the batch, generate a message authentication code on the basis thereof and tag the received data with the message authentication code: and
an openly accessible database for storing the tagged data.

20. A processor-based system (14) for storing data pertaining to a batch of items such as items of mail in a secure fashion, the system comprising:
a secure vault comprising a plurality of batch counters for recording numerical values respectively representing the number of items in the batch and a value of a physical parameter of the items in the batch;
a crypto engine in the vault adapted to receive data relating to the value of the physical parameter of an item in the batch, generate a message authentication code on the basis thereof and tag the received data with the message authentication code;
an openly accessible database for storing the tagged data; and
means for cryptographically protecting the database using the crypto engine.

21. A processor-based system according to claim 20, wherein the secure vault further comprises a batch counter for recording a numerical value representing the value of a rating parameter for the items in the batch and wherein the crypto engine is also adapted to receive data relating to the value of the rating parameter of said item and generate said message authentication code on the basis thereof as well as on the basis of data relating to the value of the physical parameter of the item in question.

22. A processor-based system according to claim 20 or 21 further comprising:
means for validating the tagged database entries using the numerical value of at least one of the batch counters and/or using the crypto engine.
